(19) United States
(12) Patent Application Publication
(10) Pub. No.: US 2002/0181040 A1
(43) Pub. Date: Dec. 5, 2002

(54) Decision circuit for high data rates as well as eye monitor, pseudoerror monitor, and system using the circuit

(75) Inventor: Eugen Lach, Marbach (DE)

Correspondence Address: SUGHRUE, MION, ZINN, MACPEAK & SEAS, PLLC, 2100 Pennsylvania Avenue, N.W., Washington, DC, 20037-3213, US

(73) Assignee: ALCATEL

(21) Appl. No.: 10/155,980

(22) Filed: May 29, 2002

(30) Foreign Application Priority Data
Jun. 5, 2001 (EP) 01 440 155.8

(51) Int. Cl. H04J 14/00

(52) U.S. Cl. 359/115

(57) ABSTRACT

Summary A decision circuit for high data rates is disclosed comprising threshold detectors between which the data stream of the incoming signals is divided, a demultiplexer stage, and EXOR gates. Using the circuit, an eye monitor and a pseudoerror monitor can be constructed. Also disclosed is a transmission system using receivers incorporating the decision circuit according to the invention.

### BACKGROUND OF THE INVENTION

The invention is based on a priority application EP 01 440 155.8 which is hereby incorporated by reference.

This invention relates to a decision circuit for high data rates comprising at least two threshold detectors between which the data stream of the incoming signals is divided, the signals from the threshold detectors being fed to respective demultiplexers followed by respective EXOR gates. Furthermore, the invention relates to an eye monitor and a pseudoerror monitor using the decision circuit. Moreover, the invention relates to a system for transmitting optical data comprising transmitters, a transmission link, and receivers in which a decision circuit for high data rates is implemented.

Aside from attenuation, signal dispersion is a major factor limiting the maximum distance and bit rate in fiber-optic systems. The effect of this dispersion and its limitations can be compensated for by suitable signal processing of the optical signal and the recovered electric signal. However, to be practical, the signal processing must be adaptive, since the dispersion effects of the fiber vary with time. The dispersion effects, which are due to polarization mode dispersion, for example, cause signal components of different polarizations to overlap. Because of these dispersion effects, the signals are smeared and arrive at the optical receiver unresolved. To separate the signals arriving at the receiver in superimposed form due to dispersion effects, use is made of nonlinear electronic filters. A nonlinear electronic filter is known from an article by Jack Winters and S. Kasturia, “Adaptive Nonlinear Cancellation for High-Speed Fiber-Optic Systems”, Journal of Lightwave Technology, Vol. 10, No. 7, pages 971 et seq. To reduce the timing problems in the nonlinear filter, two threshold detectors with different threshold levels are connected in parallel. The outputs of the parallel-connected threshold detectors are combined via a controllable multiplexer. This multiplexer operates as an EXOR gate for the incoming signals. The multiplexer has a D flip-flop and a feedback loop connected to it. Peripheral electronics determine the threshold levels to be adjusted and store them via capacitors. The time constants of the electronics are thus fixed. With such a nonlinear filter, signal distortion can be compensated if the delays between slow and fast signal components vary within one data clock period. One problem remains with this circuit. The parameters for feedback through the feedback loop of the electronic filter are derived only indirectly.

A direct measurement of the quality of a digital transmission channel is made by means of an eye diagram. The eye diagram is an excellent means to detect faults in the hardware components of a transmission system and to qualitatively describe the performance of the system. For the measurement of the eye diagram, use is made of an oscilloscope with an external trigger which is correlated with the data signals. The received optical signal is converted to an electric signal by a photodiode and applied to the Y input. With a horizontal time base of about 4 bit periods, the superimposition of the signal bits is represented by the storage capability of the oscilloscope. As a result of interference on the transmission path, the eye thus represented can close, and the smaller the eye opening, the more difficult it is to distinguish between the two binary states of the signal. To optimize the transmission channel, a direct measurement of the eye opening is therefore of great importance. The design of a fast integrated eye monitor is known from the unpublished application

DE 100 52 279.3. With this circuit it is possible to measure eye diagrams and pseudoerrors even at high data rates. The filter in the receiver is controlled with the result of the data of the eye monitor and of the pseudoerror monitor.

However, problems are already caused by the decisions of the data in the electronic filter. At high data rates, namely at rates from 40 Gb/s upwards, it is difficult for the electronic circuits to follow the clock rates. For this reason, in the prior art, the incoming data stream is divided among several threshold detectors. This reduces the clock rate at which each of the threshold detectors operates by the factor by which the data stream is divided. However, problems are caused by the EXOR gate, which must process the data streams at the high data rate.

### DESCRIPTION OF THE INVENTION

The subject matter of the invention is therefore a circuit which permits the load on the EXOR gate to be reduced and which can operate with simple circuit structures even at high data rates. This is achieved by means of a further parallel-processing stage in the circuit. Through the use of an additional multiplexer stage, the signal stream continues to be processed in parallel and the EXOR gates are operated at clock rates which are reduced by the factor of the parallel processing.

### BRIEF DESCRIPTION OF THE DRAWINGS

An embodiment of the invention will now be explained in more detail with reference to the accompanying drawings, in which:

FIG. 1 shows a prior-art circuit;

FIG. 2 shows a decision circuit according to the invention; and

FIG. 3 shows an exemplary TDM transmission system.

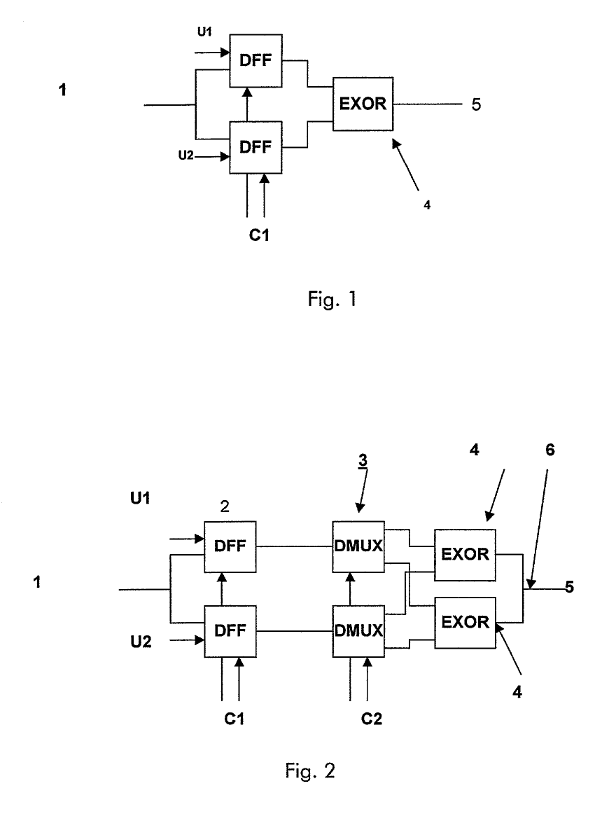

FIG. 1 shows the above-described prior art decision circuit. An incoming data stream 1 is divided between two threshold detectors 2. The threshold detectors are adjusted with different threshold levels U1 and U2. The clock rate for the parallel-connected threshold elements 2 is C1, which represents the clock rate of the input signal 1 or integral fractions thereof. The outputs of the threshold elements are applied to an EXOR gate 4. The EXOR gate also operates at the rate of the incoming data 1. The output of the EXOR gate may be coupled to an eye monitor, a pseudoerror monitor, and further processing means. As an example, a 40-Gb/s input signal has been chosen. The two threshold detectors 2 are operated in parallel at a clock rate of 40 GHz or 20 GHz. The EXOR gate, in which the signals are recombined, therefore operates at 40 Gb/s or 20 Gb/s. This example shows that a circuit as disclosed in the prior art is not suitable for processing high data rates. Up to this day, there are no EXOR gates that can be operated directly at 40 Gb/s. Therefore, no direct eye monitoring is possible with such a decision-circuit configuration.

The solution is illustrated in FIG. 2. The incoming data signal 1 is again divided between two threshold detectors 2. The two threshold detectors 2 are again adjusted with different threshold levels U1 and U2. They are operated with a first clock signal C1. The outputs of threshold detectors 2 are connected to the inputs of respective demultiplexers 3. Demultiplexers 3 are operated at a clock rate C2. Each of the demultiplexers has its outputs connected to inputs of two EXOR gates 4. The outputs of EXOR gates 4 are combined, 6, to form the desired corrected signal 5 for the eye diagram. By incorporating the additional multiplexer stage, an eye monitor for high data rates can be realized using conventional electronic components such as a normal EXOR gate. The additional demultiplexer stage does not add any bit errors.

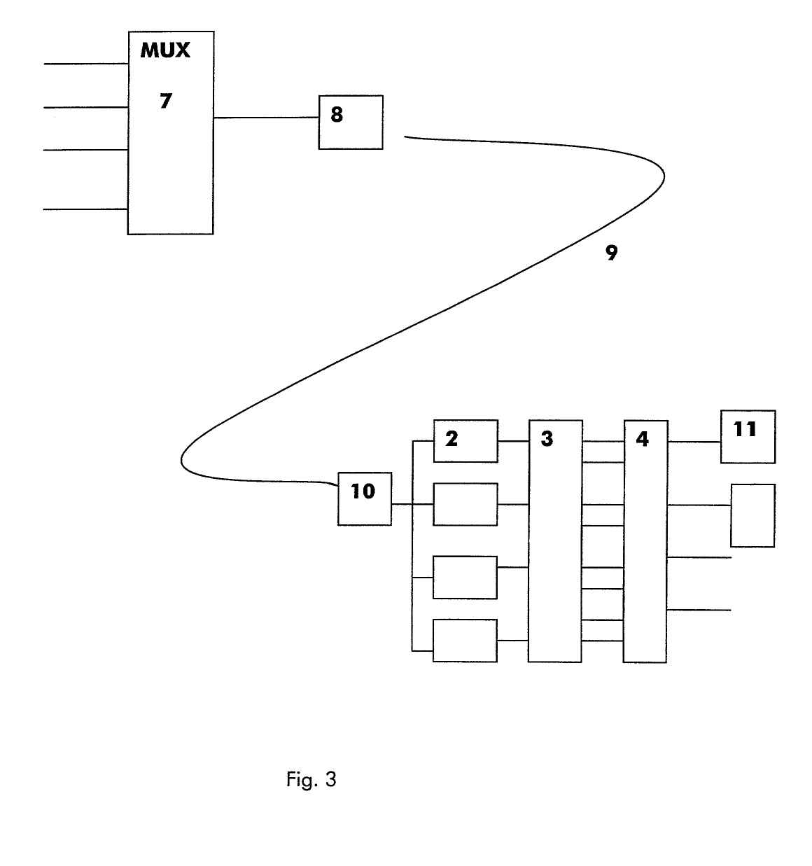

FIG. 3 shows an exemplary transmission system. In this transmission system, the data are combined on a time-division multiplex (TDM) basis. This is done in a multiplexer at the transmitting end. At the transmitting end, FIG. 3 shows schematically a multiplexer 7 with several inputs and one output, which is connected to an electrical-to-optical converter 8. The output of this electrical-to-optical converter 8 is connected to a transmission link 9. At the receiving end, there is shown an optical-to-electrical converter 10 whose output is divided among threshold detectors 2. The outputs of threshold detectors 2 are coupled to demultiplexer stage 3. In this representation, the demultiplexer stage is represented schematically by one functional block. The outputs of demultiplexer stage 3 are connected to the inputs of EXOR gate 4, also represented schematically by one block. The outputs of the EXOR gate are coupled to respective monitors 11. With such a circuit, which is shown here schematically, it is possible to precisely control a TDM transmission system. It is possible to analyze at the transmitting end the shares contributed by the individual channels in the multiplexer of the transmitter. In TDM systems, the individual data signals that are combined in multiplexer 7 come from different sources. These data sources are subject to different modulation conditions. As a result, the parameters for the transmission over a fiber-optic link are also different from the outset. At the receiving end, the circuit according to the invention in the receiver according to the invention makes it possible to observe the individual channels of the time-division multiplex and provide the parameters for the filtering. Through the circuit according to the invention, not only monitoring of the overall system, but monitoring of finely granulated channel parameters becomes possible.

1. A decision circuit for high data rates comprising at least two threshold detectors between which the data stream of the incoming signals is divided, each of the threshold detectors being connected to at least one demultiplexer, and the demultiplexers being connected to EXOR gates.

2. A decision circuit as set forth in claim 1 wherein the threshold detectors are clocked with a first clock signal and the demultiplexers with a second clock signal, with C2<C1.

3. An eye monitor using the circuit according to claim 1 wherein the outputs of the EXOR gates are connected to at least one monitor input.

4. A pseudoerror monitor using the circuit according to claim 1 wherein the outputs of the EXOR gates are connected to at least one pseudoerror-monitor input.

5. A receiver for optically transmitted data signals using the circuit according to claim 1.

6. A system for transmitting optical data comprising at least one transmitter, a transmission link, and at least one receiver, wherein at least one of the receivers comprises a circuit as set forth in claim 1.

7. A system as set forth in claim 6, wherein the data are transmitted using time-division multiplexing.
